(19) United States
(12) Patent Application Publication
(10) Pub. No.: US 2007/0142517 A1
(43) Pub. Date: Jun. 21, 2007

(54) Dry-Erase Surface Composition and Method of Applying

(76) Inventors: Andy W. Anderson SR., Villa Rica, GA (US); Michael Winchester, Canton, GA (US)

Correspondence Address: ANDY W. ANDERSON SR., 6910 Oakridge Commerce Way, Austell, GA, 30168, US

(21) Appl. No.: 11/613,446

(22) Filed: Dec. 20, 2006

Related U.S. Application Data
(60) Provisional application No. 60/752,707, filed on Dec. 21, 2005.

(51) Int. Cl. B60C 1/00; C08G 18/08

(52) U.S. Cl. 524/261; 524/492; 524/589

(57) ABSTRACT

A composition for applying to a variety of surfaces to impart dry erase properties to a substrate surface. A single component paint applied to a substrate surface by aerosol spray, brush, or roller. Currently factory applied, baked on finishes and two-part coating systems are available, but a standard single component paint formulated to withstand the penetration of dry erase markers and cleaners is not in use. Further, an endless number of colors can be produced through the addition of the appropriate pigment to the dry erase paint formulation.

### CROSS-REFERENCE TO RELATED APPLICATION

This application claims the benefit of U.S. Application No. 60/752,707, Filed Dec. 20, 2005, the contents of which are hereby incorporated by reference.

### FIELD OF THE INVENTION

This invention generally relates to visually recording and displaying information. More specifically the invention relates to visual display systems utilizing what are known as dry erase markers. With even greater particularity the invention relates to a single component, polyurethane formulation and method to convert a normal surface to have the characteristics of a manufactured dry erase surface.

### BACKGROUND OF THE INVENTION

Dry Erase surfaces have virtually replaced chalkboards as the preferred writing surface for corporate use, training centers, schools, and a wide range of other end uses. Dry erase surfaces are most commonly provided in pre-manufactured board sizes. Surfaces vary from porcelain, ceramic, melamine, and PVC. Dry Erase PVC based wall covering is another method of providing a dry erase surface. Other known dry erase coatings are two-part epoxy type coatings. For example, U.S. Pat. No. 6,265,074, issued to Shah, et al. discloses a dry erase, two part epoxy coating that is applied to flexible substrate to which an adhesive is applied. Similarly, U.S. Pat. No. 6,312,815 issued to Macris et al. and U.S. Pat. No. 4,716,056 issued to Fox et al. disclose two-part epoxy coatings that may be applied to treated and untreated surfaces. Two-part epoxy type coatings are impractical in the field, requiring highly skilled labor and specific equipment for mixing and application. Furthermore, once the two parts of the epoxy are mixed, the product has a very limited pot life measured in hours, not days or weeks.

Other methods of producing dry erase surface include fire-coated glazes, such as that disclosed in U.S. Pat. No. 4,123,590 issued to Hasegawa et al. As disclosed by U.S. Pat. No. 5,037,702, issued to Pitts et al. indicate that other one part coatings in the art require specialized curing such as high temperatures, ultraviolet (UV) and/or electron beam (EB) curing lights in order to exhibit favorable dry erase characteristics. White is the predominate color being sold and utilized.

Pre-manufactured dry erase boards provide varying levels of performance over their life, depending on the writing surface used. On the less expensive melamine boards, performance is compromised for a lower price, but the limitation on all pre-manufactured boards is that a customer is limited to only the sizes offered. While dry erase wall covering can be installed to cover an entire wall surface, corner to corner and floor to ceiling, it is a very expensive installation and requires skilled labor. Failure of the dry erase surface will require removal of the wallcovering, wall preparation, and re-hanging new material.

The inks of the typical, dry erase markers, such as Sanford Expo Bold Dry Erase Marker (Sanford Division of Newell Rubbermaid, Inc., 2707 Butterfield Road, Oak Brook, Ill. 60523) will not penetrate the surface, thereby erasing with minimal effort. Those standard markers will not “ghost”, and the cleaners, such as Sanford Blue Expo white board cleaner (containing 2-Butoxy Ethanol/Acetate, Isopropyl Alcohol), may be used to maintain dry erase surfaces.

### BRIEF SUMMARY OF THE INVENTION

The invention comprises a single component, solvent based paint composition that may be applied to a surface by conventional painting techniques including brushing, rolling, and spraying, to impart or improve the dry erase characteristics of the surface, which may include gypsum wall board, chalkboards, whiteboards, dry erase PVC wall coverings, and other plastic surfaces, metal, MDF, masonry, stone, and any number of other wall or display surfaces.

The base component comprising our invention is a solvent based paint with a high performance polyurethane resin system, that is used extensively in the marine industry. The base component is sold under the trademark BRIGHTSIDE and is manufactured by International Paint, 2270 Morris Ave., Union, N.J. 07083 and owned by Akzo Nobel, UK. The paint's inherent properties of hardness, weather resistance, chemical resistance and abrasion resistance translate very well for use as a dry erase surface finish.

To achieve the improved dry erase characteristics of the present invention, we have added varying amounts of polytetrafluoroethylene (PTFE) and hydrozy alkyl polydimethylsiloxane. The polytetrafluoroethylene (PTFE) or TEFLONn® is available from E.I. DuPont de Nemours and Company, Wilmington, Del. The hydroxyl alkyl polydimethylsiloxane additive is available commercially under the trademame TEGO Protect 5000 (Product Code 200512) from Goldschmidt Chemical Corporation, 914 East Randolfph Road, Hopewell, Va. 23860.

According to our invention PTFE and TEGO 5000 are added to the Brightside polyurethane base component in amounts of between about 0.50% by weight to 10% by weight, more preferably 0.50% by weight to 5% by weight. We found that adding PTFE and TEGO 5000 in amounts above 3% by weight tended to dull the resultant dry erase surface and amounts of 1% by weight represent the most cost effective results in terms of resultant dry erase performance.

### DETAILED DESCRIPTION OF THE INVENTION

Previously, the challenge of producing a single component, pigmented, field applied dry erase paint has not been accomplished. The present invention is a single component, air cured dry erase paint that can be applied on a variety of substrates to produce an improved dry erase surface for standard dry erase type markers.

Two-part epoxy type coatings are impractical in the field, requiring highly skilled labor and specific equipment. Further once the two parts are mixed, the product has a very limited pot life measured in hours, not days or weeks. When compared to existing dry erase surface coatings on the market, the cost of labor and material for the dry erase paint of the present invention and its application is about 50% less expensive, and the dry erase formulation contains no polyvinyl chloride, which has negative environmental implications.

The invention provides for a painted on dry erase surface that can be applied to a number of substrate surfaces, including over gypsum board, chalkboards, whiteboards, dry erase PVC wall covering, PVC wall covering, and other plastic surfaces, metal, MDF, and any number of other wall surfaces. The ability to impart dry erase properties on any wall surface through the use of a single component paint represents a substantial advance in the art.

The base component of our composition is a proprietary polyurethane resin, solvent based paint with a high performance polyurethane resin system, which is used extensively in the marine industry. Brightside polyurethane is formulated for marine applications and produces a high gloss finish. Brightside polyurethane has self-leveling properties, has color retention properties, and is abrasion resistant and durable.

The base component comprising our invention is a solvent based paint with a high performance polyurethane resin system, that is used extensively in the marine industry. The base component is sold under the trademark BRIGHTSIDE and is manufactured by International Paint, 2270 Morris Ave., Union, N.J. 07083 and owned by Akzo Nobel, UK. BRIGHTSIDE polyurethane is ready mix of one part linear polyurethane topside finish. The paint's inherent properties of hardness, weather resistance, chemical resistance and abrasion resistance translate very well for use as a dry erase surface finish.

The ingredients for the BRIGHTSIDE polyurethane base composition are shown in the following table 1:

TABLE 1
Characteristics of Brightside Polyurethane Base Composition

| C.A.S. | | |
|---|---|---|
| Number | % Weight | Chemical Name |
| | | Alkyd Resin |
| | | Urethane Alkyd |
| 000091-20-3 | 0.10-1.0 | Naphthalene |
| 07691-86-9 | 1.0-10 | Silica, amorphous |
| 08052-41-3 | 10-25 | Stoddard solvent |
| 064742-47-8 | 1.0-10 | Aliphatic Hydrocarbon |
| 013463-67-7 | 10-25 | Titanium Dioxide |
| 021645-51-2 | 1.0-10 | Aluminum hydroxide |
| 064742-88-7 | 10-25 | Solvent naphtha (petroleum), medium aliphatic |
| 064742-94-5 | 1.0-10 | Naphtha (petroleum), heavy aromatic |

To achieve the improved dry erase characteristics of the present invention, we have added varying amounts polytetrafluoroethylene (PTFE) and hydrozy alkyl polydimethylsiloxane. The polytetrafluoroethylene (PTFE) or Teflon® is available from E.I. DuPont de Nemours and Company, Wilmington, Del. The hydroxyl alkyl polydimethylsiloxane additive is available commercially under the trademame TEGO Protect 5000 (Product Code 200512) from Goldschmidt Chemical Corporation, 914 East Randolfph Road, Hopewell, Va. 23860. Adding Tego 5000 and PTFE to the existing BRIGHTSIDE paint produces enhanced dry erase properties, resistance to cleaning solutions, and longer term performance. The surface hardens as these additives migrate to the surface of the paint, requiring a 4 day minimum curing time before the surface can be used. The surface continues to cure for approximately 30 days, at which point it reaches its maximum hardness.

The ranges for the percentage weights of the TEGO 5000 and PTFE additives are shown in the following Table 2.

TABLE 2
Additives

| | Percentage Weight | | |
|---|---|---|---|
| | Suitable | | Optimum |
| Chemical Name | Performance | High Gloss | Performance |
| Polytetrafluoroethylene | 0.50%-10% | 0.50%-3.0% | 0.50%-1.0% |
| Hydroxyl alkyl | 0.50%-10% | 0.50%-3.0% | 0.50%-1.0% |
| polydimethylsiloxane | | | |

The dry erase paint formula of the present invention exhibits superior release properties, meaning that a standard dry erase marker, such as the Sanford Expo Bold Dry Erase Marker (Sanford Division of Newell Rubbermaid, Inc., 2707 Butterfield Road, Oak Brook, Ill. 60523) will not penetrate the surface, thereby permitting erasure of the marks with minimal effort. When used with the composition of the present invention, those standard markers will not “ghost”, i.e. leave residual marks, and the cleaners, such as Sanford Blue Expo white board cleaner (containing 2-Butoxy Ethanol/Acetate, Isopropyl Alcohol), used to maintain dry erase surfaces will not damage the resultant dry erase surface produced by the composition of the present invention.

The one part composition of the present invention may be used by any commercial painting contractor and particularly lends itself to home and other do-it-yourself applications, who are unlikely to invest in the costly equipment required for two-part epoxy finishes or prohibitively expensive curing systems required for other one part compositions, such as UV and EB.

While white is typically the color of choice for dry erase displays, the one part dry erase paint composition of the present invention is also amenable to receiving tints and pigments so that the final dry erase surface may have an unlimited color selection suitable for the desired display application. For example a display conveying warnings may be colored red and a display conveying safety information may be colored green. In an educational or corporate environment, team or institutional colors may be popular choices.

As with most any painting project, the surface being treated should be free of dirt, oils, debris, and other contaminants. The area should be substantially free of residual dust, particulates, or other construction debris floating in the air as they may adhere to the paint and create unwanted particles that would be detrimental to the suitability of the resultant dry erase writing surface.

Depending upon the particular substrate selected for the dry erase surface, a primer may or may not be required. However, to obtain the best results the inventors recommend the application of a suitable primer coat prior to applying the composition of the present invention. In our tests we applied a coat of Benjamin Moore acrylic latex primer to drywall, and permitted it to dry for 24 hours.

A moderate coat of the dry erase paint of the present invention is applied to the substrate by any conventional painting methods such as brushing, rolling, or spraying. Because the dry erase paint is a solvent based composition, it is preferable during on-site application that it be applied with a brush or roller to limit the amount of vapors released during application.

The inventors have found that a suitably smooth dry erase surface may be obtained with as single coat of the dry erase paint liberally applied with a sponge nap roller. The best rolled surface may be obtained by utilizing a painting technique referred to as laying off, in which a partially wet roller is lightly rolled over the freshly coated surface. A 1/4 inch sponge nap roller is the preferred roller for this purpose.

Ideally this application technique will achieve a desired coating thickness of between about 1-3 mils. If too light a coat is applied the desired dry erase properties are compromised. Whereas, application of too heavy a coat causes the curing time to be extended and the coverage area for a given volume of paint reduced. Ideally a single coat is applied at the desired thickness.

To assist in ensuring complete coverage, it may be desirable that the primer coat have a slightly different tint from the color selected for dry erase paint to permit the person applying the dry erase paint to differentiate those portions that have received an adequate coating from those portions that remain untreated.

After the dry erase paint has been applied to the substrate it is best to allow the resulting dry erase writing surface to dry for at least 96 hours (4 days) before using. This allows the proper components of the dry erase paint to migrate to the surface. The surface hardens as these additives migrate to the surface of the paint, and a 4 day minimum curing time before the surface can be used. The surface continues to cure for approximately 30 days, at which point it will reach its maximum hardness.

Unlike conventional dry erase boards and surfaces, should the painted surface contemplated by the present invention ever fail to perform due to mistreatment or accidental damage, the surface can be readily re-painted, bringing the surface back to its original level of performance. Indeed, the dry erase paint of the present invention may be used to economically repair or restore a conventional dry erase surface that had been damaged or otherwise had its dry erase properties diminished through excessive, and in some instances routine use. This is a much more economical repair than conventional methods, particularly with respect to PVC dry erase wall coverings which typically require the complete removal of the wall covering, repairing and prepping the wall surface to a level five finish, and the re-hanging the PVC dry erase wall covering.

In gauging the effectiveness of different levels of the additives, we conducted experiments evaluated against several elements to determine the performance characteristics of the resultant dry erase surface. Among the elements we considered in our evaluation are: marker erasability; resistance to cleaning solutions; and marker registration, or lack thereof, due to wetting, which is indicated by the ink beading on the surface.

To remain consistent between test groups, all markings were made with Sanford Expo Bold Dry Erase Markers (Sanford Division of Newell Rubbermaid, Inc., 2707 Butterfield Road, Oak Brook, Ill. 60523). We tested black, blue, green, and red markers, as some colors are more resistant to removal than others. At the time of this application, we have only evaluated the performance of the resultant dry erase surface with the aforementioned Sanford Expo Bold Markers.

While we expect that the surface obtained with the dry erase paint composition of the present invention will respond well to other markers, eraser types, and cleaners, our testing was confined to marker products that showed the best compatibility to our paint. Low odor markers, like the Expo Low Odor Marker, also by Sanford Division of Newell Rubbermaid, Inc., 2707 Butterfield Road, Oak Brook, Ill. 60523 have demonstrated a tendency to penetrate the painted surface and are therefore not recommended for use. We recommend that any non-Expo Bold Marker be tested in a discrete portion of the finished dry erase board, or a sample test board prepared for this purpose, to ensure its dry erase characteristics prior to extensive use.

As a testing protocol, on a scale of 0-10 we quantified the removal of the markers' ink from the treated surface following 48 hours of drying time. As an example, we wrote on the surface to be tested on Monday at 9:00 a.m. then tested the marker's removal on Wednesday at 9:00 am. According to our scale, 0 represents no removal of the dry erase ink, whereas 10 represents complete removal of the ink from the dry erase surface. Many painted surfaces that we tested could be erased within 5 minutes of applying the marker, but after hours or days, all of those failed, receiving a “0”, with the exception of the paint of the present invention.

We prepared a drywall substrate primed with Benjamin Moore Acrylic Latex primer and allowed the primer to dry for 24 hours. The selected paints for our test groups were applied with a ¼″ nap sponge roller and allowed each to cure for four days before marking and attempting removal of the markings. We used Mr Clean Magic Eraser for removal of the markings in each test group.

Tests were based on achieving a coating thickness of 1 to 3 mils in the dry erase paint layer. If too light a coat is applied, the dry erase properties are compromised. Applying too heavy a coat causes the curing time to be extended the coverage estimate for a given quantity of paint to be reduced. Ideally a single coat is applied at the suggested thickness. The lighter the coat, the quicker and more thoroughly the paint cures and the better the performance.

### EXAMPLE 1

As a control we applied a coat of Brightside only, with no additives. When testing Brightside only, with no additives, these same scores were 9 after 48 as shown in the following Table 3.

### EXAMPLE 2

For example two, we added only TEGO to the Brightside base component in 0.50% increments from 0.5% to 2.0%, and 1.00% increments between 2.00% to 10.00%. Example two achieved its best performance at 1.50% and 2.00%, receiving a 9.5 rating.

### EXAMPLE 3

Example three was a mixture of the Brightside base component with only PTFE added in increments of 0.50% between 0.50% to 2.00%, and 1.00% increments between 2.00% and 10.00%. The best results for the PTFE only sample were obtained between 0.50% and 1.50%. However, the dry erase surface obtained with PTFE additive only achieved a high of 8.5 and its performance degraded to 8 and 7 as greater amounts of PTFE were added.

### EXAMPLE 4

The fourth example was a mixture of the Brightside base component and equal parts of TEGO and PTFE. As with the prior examples, the TEGO and PTFE were added in 0.50% increments between 0.05% and 2.00% and in 1.00% increments between 2.00% and 10.00%. The best results were obtained for this formulation at 1.00% and 1.50% TEGO and PTFE, which received scores of 10 at these concentrations. Between 0.50% and 2.00%, the formulation achieved scores of at least 9.5, and between 0.50% and 10% TEGO and PTFE, scored at least 9. The ultimate formulation (Brightside, 1% TEGO, 1% PTFE) received a score of 10 on all colors after marking and leaving on the dry erase surface 48 hours.

The results of our testing after 48 hours drying time is summarized in the following Table 3:

TABLE 3

| | Example | | | |
|---|---|---|---|---|
| | 1 | 2 | 3 | 4 |
| Additives % by | Brightside | Brightside + | Brightside + | Brightside + |
| Weight | Only | TEGO | PTFE | TEGO + PTFE |
| 0 | 9 | — | — | — |
| 0.50 | — | 9 | 8.5 | 9.5 |
| 1.0 | — | 9 | 8.5 | 10 |
| 1.5 | — | 9.5 | 8.5 | 10 |
| 2.0 | — | 9.5 | 8 | 9.5 |
| 3.0 | — | 9 | 8 | 9 |
| 4.0 | — | 9 | 8 | 9 |
| 5.0 | — | 8.5 | 8 | 9 |
| 6.0 | — | 8.5 | 8 | 9 |
| 7.0 | — | 8.5 | 7 | 9 |
| 8.0 | — | 8.5 | 7 | 9 |
| 9.0 | — | 8.5 | 7 | 9 |
| 10.0 | — | 8.5 | 7 | 9 |

The selected formulation (Brightside+1% Tego 5000+1% PTFE) was tested for resistance to damage from the most commonly used whiteboard cleaner on the market, EXPO BLUE CLEANER. This paint formulation passed 100 double rubs without damage to the writing surface, rating a perfect 5 according to ASTM D4752.

In that this is a field-applied paint, we are recommending specific markers, erasers and cleaners to maximize the performance and life of the painted surface. Although the dry erase paint surface of the present invention may respond well to other markers, eraser types, and cleaners, our testing was confined to the products that showed the best compatibility to our paint. Low odor markers in particular have a tendency to penetrate the painted surface and are therefore not recommended for use. Any non-Expo Bold Marker must be tested for use on the board before extensive use.

For best results, it is recommended that the single part dry erase paint be sold in a kit, including a can of the dry erase composition of the present invention, a can of the substrate primer, an eraser, and an assortment of compatible dry erase markers. By including each of the components in the kit, maximum compatibility of the various elements are ensured, particularly for do-it-yourself projects.

It should be understood that although examples of preferred embodiments of the invention have been disclosed herein in some detail, modifications and variations might be made without departing from the spirit and scope of the invention. Accordingly, all forms of the invention are claimed that come within the scope of the appended claims.

We claim:

1. A single part paint composition for imparting dry erase properties to a substrate comprising a mixture of:
a. an alkyd resin and urethane alkyd base component; and
b. substantially equal parts by percent weight of hydroxyl alkyl polydimethylsiloxane and polytetrafluoroethylene.

2. The composition of claim 1 wherein said hydroxyl alkyl polydimethylsiloxane is added in an amount of between about 0.5% by weight to about 10% by weight and said polytetrafluoroethylene is added in an amount of between about 0.5% by weight to about 10% by weight.

3. The composition of claim 1, said hydroxyl alkyl polydimethylsiloxane is added in an amount of between about 0.5% by weight to about 2% by weight and said polytetrafluoroethylene is added in an amount of between about 0.5% by weight to about 2% by weight.

4. The composition of claim 1, said hydroxyl alkyl polydimethylsiloxane is added in an amount of between about 1% by weight to about 1.5% by weight and said polytetrafluoroethylene is added in an amount of between about 1% by weight to about 1.5% by weight.

5. The composition of claim 1, wherein said base component further comprises between about: 0.1 to 1.0% by weight naphthalene; 1.0 to 10% by weight amorphous silica; 10 to 25% Stoddard solvent; 1.0 to 10% aliphatic hydrocarbon; 10 to 25% titanium dioxide; 1.0 to 10% aluminum hydroxide; 10 to 25% solvent naphtha (petroleum), medium aliphatic; and 1.0 to 10% naphtha (petroleum), heavy aromatic.

6. A method of treating a substrate to impart dry erase properties on a surface of the substrate comprising:
a. obtaining a single part alkyd resin and urethane alkyd base component;
b. mixing said single part alkyd resin and urethane alkyd base component with substantially equal parts by percent weight of hydroxyl alkyl polydimethylsiloxane and polytetrafluoroethylene, to form a single part dry erase paint;
c. applying said single part dry erase paint to a surface of a substrate; and
d. allowing said single part dry erase paint sufficient time to dry.

7. The method of claim 6 further comprising:
a. applying an acrylic latex primer to said substrate surface, before applying said single part dry erase paint to said substrate surface.

8. The method of claim 6 wherein said step of mixing said substantially equal parts by weight of hydroxyl alkyl polydimethylsiloxane and polytetrafluoroethylene, comprises adding said hydroxyl alkyl polydimethylsiloxane in an amount of between about 0.5% by weight to about 10% by weight and said polytetrafluoroethylene in an amount of between about 0.5% by weight to about 10% by weight.

9. The method of claim 6, wherein said hydroxyl alkyl polydimethylsiloxane is added in an amount of between about 0.5% by weight to about 2% by weight and said polytetrafluoroethylene is added in an amount of between about 0.5% by weight to about 2% by weight.

10. The method of claim 6, wherein said hydroxyl alkyl polydimethylsiloxane is added in an amount of between about 1% by weight to about 1.5% by weight and said polytetrafluoroethylene is added in an amount of between about 1% by weight to about 1.5% by weight.

11. The method of claim 6, wherein said base component further comprises between about: 0.1 to 1.0% by weight naphthalene; 1.0 to 10% by weight amorphous silica; 10 to 25% Stoddard solvent; 1.0 to 10% aliphatic hydrocarbon; 10 to 25% titanium dioxide; 1.0 to 10% aluminum hydroxide; 10 to 25% solvent naphtha (petroleum), medium aliphatic; and 1.0 to 10% naphtha (petroleum), heavy aromatic.

12. The method of claim 6, wherein said substrate is selected from the group consisting of gypsum wall board, chalkboards, whiteboards, dry erase PVC wall coverings, plastic, metal, MDF, wood, masonry, and stone.

13. The method of claim 6, wherein the step of applying said single part dry erase paint to a surface of a substrate comprises; rolling, brushing, or spraying.

14. A kit comprising: a can of a single part dry erase paint comprising a single part alkyd resin and urethane alkyd base component premixed with substantially equal parts by percent weight of hydroxyl alkyl polydimethylsiloxane and polytetrafluoroethylene; a can of an acrylic latex substrate primer, a dry-marker eraser, and an assortment of compatible dry erase markers.

15. The kit of claim 14 wherein said can of single part alkyd resin and urethane alkyd base component is premixed with said hydroxyl alkyl polydimethylsiloxane in an amount between about 0.5% by weight to about 10% by weight and adding said polytetrafltoroetliylene in an amount of between about 0.5% by weight to about 10% by weight.

16. The kit of claim 14, said can of single part alkyd resin and urethane alkyd base component is premixed with said hydroxyl alkyl polydimethylsiloxane in an amount between about 0.5% by weight to about 2% by weight and said polytetrafluoroethylene is added in an amount of between about 0.5% by weight to about 2% by weight.

17. The kit of claim 14, said can of single part alkyd resin and urethane alkyd base component is premixed with said hydroxyl alkyl polydimethylsiloxane is an amount of between about 1% by weight to about 1.5% by weight and said polytetrafluoroethylene is added in an amount of between about 1% by weight to about 1.5% by weight.
